(19) United States
(12) Patent Application Publication
(10) Pub. No.: US 2005/0117270 A1
(43) Pub. Date: Jun. 2, 2005

(54) Profile arrangement for jamming protection and injection mould

(75) Inventor: Marc Scherraus, Ulm (DE)

Correspondence Address: CROWELL & MORING LLP;INTELLECTUAL PROPERTY GROUP, P.O. BOX 14300, WASHINGTON, DC, 20044-4300, US

(73) Assignee: Mayser GmbH & Co. KG, Ulm (DE)

(21) Appl. No.: 10/968,177

(22) Filed: Oct. 20, 2004

Related U.S. Application Data
(60) Provisional application No. 60/512,197, filed on Oct. 20, 2003.

(30) Foreign Application Priority Data
Oct. 20, 2003 (DE) 103 49 650.5

(51) Int. Cl. E05F 15/02

(52) U.S. Cl. 361/302; 49/27

(57) ABSTRACT

Profile arrangement for jamming protection and injection mould are provided. A connecting portion of a support profile constructed as a plastic injection moulding and a fastening area of a zonally elastically flexible switching profile are constructed as positively interconnectable plug-in profilings.

The present application claims the benefit of priority under 35 U.S.C. § 119 to German Patent Application No. 103 49 650.5, filed Oct. 20, 2003 and U.S. Provisional Patent Application No. 60/512,197, filed Oct. 20, 2003. The entire disclosure of the aforementioned applications is herein expressly incorporated by reference.

### BACKGROUND AND SUMMARY OF THE INVENTION

The invention relates to a profile arrangement with a support profile, especially constructed as a plastic injection moulding, and with an at least zonally elastically flexible switching profile, which is connected by means of a fastening area to a corresponding connecting portion of the support profile, as well as an injection mould for the manufacture of the support profile.

Such profile arrangements are known from the prior art for securing driven, automatically movable closure elements such as the tailgates of motor vehicles or safety doors in buildings or on machines. Profile arrangements are produced in one piece or as an assembly from a stable support profile and an elastic switching profile. On installing the assembly it is possible to provide an adhesive connection between the support profile and the switching profile. This adhesive connection can be implemented by the application of a double-sided adhesive tape to the switching profile and a subsequent sticking of the switching profile to the support profile. In order to ensure a good adhesion of the adhesive tape on the switching profile and the support profile, it is necessary to carry out preliminary work such as cleaning processes or the application of liquid activators which, together with the costs for the adhesive tape, represent a significant cost factor with regards to the profile arrangement.

In this connection, U.S. Pat. No. 6,297,605 B1 discloses a device for an electrically driven tailgate, which is equipped with a catching or jamming protection device. For this purpose is provided on a tailgate frame a switching strip applied to a deformable support and which is connected to a control unit. The control unit controls a drive motor for the movement of the tailgate. During a tailgate closing movement a body part or object which is jammed or caught between the tailgate and the tailgate frame gives rise to an operating force on the switching strip. Thus, an electrical contact is produced in the switching strip and triggers an electric signal. This electric signal is transmitted to the drive motor control device. The control unit initiates a direction reversal of the drive motor so as to swing up the tailgate and release the jammed body part or object. As it is impossible to bring about an immediate reversal of the tailgate on releasing the switching strip due to the inertia of the control unit, the drive motor and the tailgate, in order to avoid injury or damage it is necessary to ensure a buffer path between the switching strip and the tailgate frame. For this purpose the switching strip is applied to the deformable support, which with a limited operating force can at least be deformed to such an extent that serious injuries or damage can be avoided up to the time of reversing the direction of the tailgate.

The problem of the invention is to provide a profile arrangement of the aforementioned type and an injection mould for the manufacture of a support profile for the profile arrangement, through which in an inexpensive manner it is possible to ensure a secure connection between the support profile and the switching profile.

This problem is solved in that the connecting portion of the support profile and the fastening area of the switching profile are constructed as plug-in profilings interconnectable in a positive manner. As a result it is possible to implement a particularly reliable connection between the support profile and the switching profile, whose loadability is only dependent on the mechanical characteristics of the plug-in profilings. This obviates the need for all preparatory steps, such as are needed when using adhesive tape. As a result of the positive connection of the plug-in profilings a high reliability is still brought about with complexly shaped support profiles with a pronounced spatial curvature leading to a permanent static loading of the connecting portion between the switching profile and the support profile. The support profile is preferably constructed as a plastic profile, but in other embodiments can also be made at least partially of metal.

According to a development of the invention the switching profile is constructed as a hollow profile without a switching function. Thus, the profile arrangement can be used as a passive jamming protection in uncritical areas or for supplementing other jamming protection measures. The profile arrangement can also be used as a particularly flexible seal, particularly between covers or vehicle parts.

According to a further development of the invention at least one plug-in profiling of the support profile or the switching profile is constructed as a slot open to at least one face, and at least one corresponding plug-in profiling of the switching profile or the support profile is constructed as a web arrangement matched to a cross-section of the slot for fitting into one another in the sliding direction. The switching profile together with its corresponding plug-in profiling can be inserted preferably frontally into the corresponding plug-in profiling of the stationary support profile. The concept of insertion includes both sliding in and drawing in. The web arrangement preferably has a L-like or T-like cross-section. The slot is therefore correspondingly provided with a L or T-like cross-section. It is alternatively possible to provide the slot with a dovetail cross-section. The slot is open to at least one of its two faces. A narrowing of the slot is provided for securing the positive connecting portion preferably in the direction of the particular surface against which the corresponding plug-in profiling engages in the inserted state. The plug-in profilings, i.e. the at least one slot and the at least one web arrangement are so matched to one another with respect to their cross-section that in the inserted state the web arrangement is non-positively fixed in the slot in the sliding or drawing direction and is also positively held in the slot at right angles to the sliding or drawing direction. Through the mutually matched plug-in profilings the switching profile can preferably be drawn up onto the plug-in porifling of the support profile along a main extension direction of said corresponding plug-in profiling of the support profile. Preferably the web arrangement is provided on the support profile and with the switching profile is associated a slot running in the longitudinal direction of the switching profile and matched to the cross-section of the web arrangement and by means of which said switching profile can be drawn onto the support profile.

According to a further development of the invention, the web arrangement and the at least one slot are so positively matched to one another that a positive retention at right angles to the sliding direction is ensured. This ensures that the switching profile is not removed from the support profile and in particular not from the slot by forces and/or moments, which have no preponderant components in the sliding direction. This applies for as long as the slot or switching profile is not damaged or so considerably deformed that an anchoring in the slot can no longer be ensured. In this way it is possible to respect test standards, such as are used as a basis for motor vehicles or machine tools. These testing standards require the ensuring of specific shearing and/or tearing-out forces for the switching profile from the support profile.

According to a further development of the invention, the at least one plug-in profiling of the support profile is constructed as a locking recess and the at least one plug-in profiling of the switching profile is in the form of a lug or web-like locking element, which can be engaged in one another at right angles to an opening plane of the locking recess. The locking recess and the locking element have at least one undercut, which ensures a positive retention of the locking element in the locking recess, at least counter to an insertion direction. Thus, the switching profile with its lugs or web-like locking elements can be engaged perpendicular to the surface of the support profile in which is provided the plug-in profiling in the form of a locking recess. This obviates the need for a complete sliding in of the switching profile over the entire support profile length, which leads to a much easier installation process, particularly in the case of spatially curved support profiles. The support profile can also be easily manufactured, because the locking recesses can be produced in the form of holes or slits with a constant cross-section.

According to a further development of the invention, a longitudinal extension of the locking recess is larger than a corresponding locking element extension, the locking recess, considered in the longitudinal extension, having at least two differently wide opening cross-sections, which are matched to different cross-sectional areas of the locking element, whereof one cross-sectional area at the front in the insertion direction forms an undercut area and a following cross-sectional area forms a sliding area. Thus, a fitting of the switching profile to the support profile can be brought about with a short locking movement. In a first step of the locking movement the switching profile is placed on the support profile orthogonally to the longitudinal extension of the locking recess. The locking elements slide into the sliding area of the slot and no positive locking occurs. In a second step of the locking movement the switching profile is moved in the direction of the longitudinal extension, the locking elements slide along the slot into the undercut area and are consequently positively locked with the support profile. As a result of such an assembly procedure, even in the case of complex, spatially curved support profiles, it is possible to ensure a reliable positive engagement with the switching profile. As there is no need for any significant deformation of the locking elements or locking recesses, only a limited assembly force is needed.

According to a further development of the invention, in the sliding direction there is a cross-sectional difference to the sliding area or the corresponding opening cross-section. This makes it possible to wedge and jam in the sliding-in direction, so that a non-positive engagement is brought about in addition to the existing positive engagement.

According to another development of the invention, the connecting section of the support profile is constructed as an extension of an elastically flexible compensating portion. Thus, the switching profile is held on the support profile in the extension of the elastically flexible compensating portion, so that in accordance with the previously described prior art there is a flexibility of the compensating portion in the case of corresponding switching profile loading.

According to a further development of the invention, in the longitudinal direction and in the area of a top side, the slot is provided in alternating, pairwise manner with in each case one larger and one smaller opening cross-section and in the area of its underside with crossbars and recesses, the crossbars facing the larger opening cross-sections and the recesses facing the smaller opening cross-sections. This permits the manufacture of the support profile as a plastic injection moulding with virtually random three-dimensional curvature paths. In known support profiles at best undercuts can be implemented by sliders in an injection mould and can only have a very limited extension. As a result of the alternating, pairwise arrangement of larger and smaller opening cross-sections and facing crossbars and recesses, it is possible to have a randomly long, undercut slot in the plastic injection moulding process for a support profile. The crossbars are used for the connection of support profile areas otherwise separated from one another by the larger and smaller opening cross-sections and recesses. The lined up opening cross-sections and recesses form the slot in the support profile. In order to implement the opening cross-sections and recesses, mould cores are provided in the injection mould. During an injection moulding process, the mould cores keep free the opening cross-sections and recesses.

The fundamental problem of the invention is also solved by an injection mould for the manufacture of a support profile, in which an external geometry of the support profile to be manufactured is introduced as a mould cavity in at least two mould parts, which are in contact in a common junction plane and have mould cores, which are positioned at least approximately orthogonally to the junction plane and which in their functional position define a support profile slot undercut with respect to the junction plane. The injection mould has a mould cavity, in the form of a hollow space, formed by at least two mould parts and which represents the external geometry of the support part to be manufactured. Plasticized plastic is introduced into said mould cavity for the manufacture of the support profile, completely filling said cavity and which can be subsequently cooled. In order to be able to make the inventively undercut slot in the support profile during the injection moulding process, mould cores are provided in the mould parts. The mould cores are arranged in alternating, pairwise manner and keep free larger and smaller opening cross-sections and also recesses in the support profile and consequently form the undercut slot in said support profile. Through the use of mould cores which, in the case of a spatially curved slot configuration, can at least zonally be made in movable form, it is possible to bring about an almost random spatial curvature of the support profile and the slot to be made therein, even in the case of a plastic injection moulding.

Other objects, advantages and novel features of the present invention will become apparent from the following detailed description of the invention when considered in conjunction with the accompanying drawings.

### BRIEF DESCRIPTION OF THE DRAWINGS

Further advantages and features of the invention can be gathered from the claims and the following description of preferred embodiments relative to the attached drawings, wherein the attached drawings show:

FIG. 1a Perspectively a diagrammatic view of a tail area of a motor vehicle with an electrically driven tailgate and profile arrangements on either side of a tailgate frame.

FIG. 1b Perspectively a diagrammatic view of a tail area of a motor vehicle with an electrically driven tailgate and profile arrangements on either side of the tailgate.

FIG. 2 An isometric projection of a profile arrangement with a switching profile to be slid in laterally.

FIG. 3 A planar sectional representation of a profile arrangement according to FIG. 2 in a rest position.

FIG. 4 A planar sectional representation of a profile arrangement according to FIGS. 2 and 3 in an operating position.

FIG. 5 In isometric projection a profile arrangement for the orthogonal sliding in of the switching profile with subsequent surface-parallel locking movement.

FIG. 6 In isometric projection a switching profile for orthogonal locking.

FIG. 7 In isometric projection a switching profile for orthogonal sliding into a support profile with variable slot cross-section.

FIG. 8 In a planar sectional representation a profile arrangement according to FIGS. 6 or 7 in a rest position.

FIG. 9 In isometric projection a switching profile for orthogonal mounting.

FIG. 10 In a planar sectional view a profile arrangement to FIG. 9 in a rest position.

FIG. 11 A perspective diagrammatic view of an injection mould.

FIG. 12 A larger scale sectional representation of a detail of a tail area of a motor vehicle in the vicinity of a tailgate frame.

FIG. 13 In an even larger scale sectional representation a detail of FIG. 12.

FIG. 14 In an even larger scale sectional representation the switching profile of the construction according to FIGS. 12 and 13.

### DETAILED DESCRIPTION

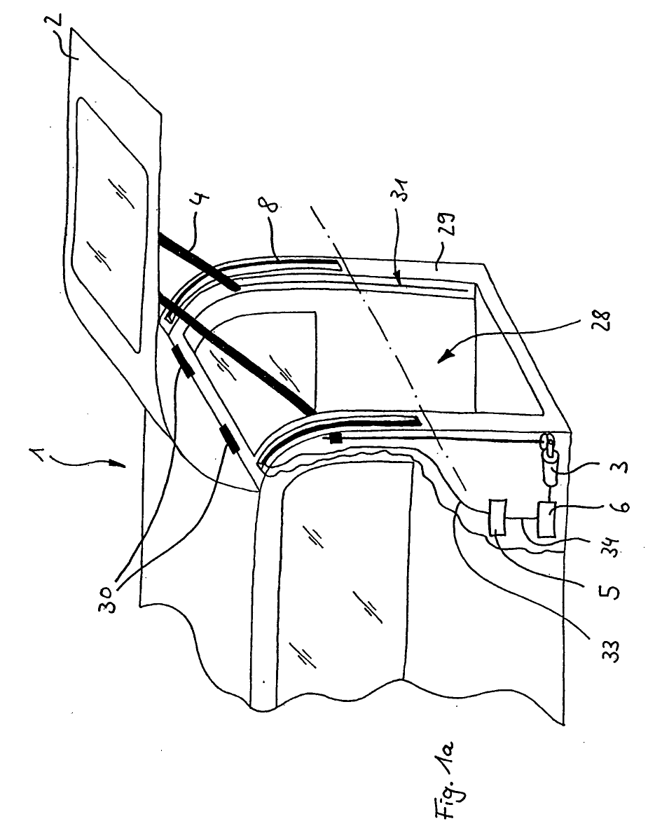

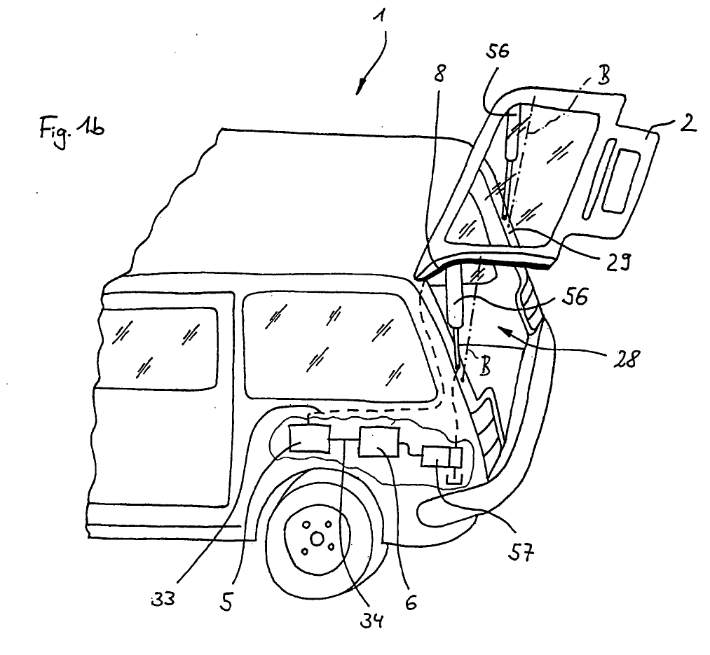

A motor vehicle tail area 1 shown in FIG. 1a has a rear luggage area opening 28, which is bounded by a tailgate frame 29. On a top side of the tailgate frame 29 a tailgate 2 is pivotably connected thereto via tailgate hinges 30. On either side of the insides of the luggage area opening 28 are provided guide rails 31 in each of which is slidably guided an operating rod 4 by means of a flexible screw spindle 32. The screw spindle 32 is rotated by a motor drive 3 and consequently permits a displacement of the operating rod 4, which is connected to the screw spindle 32 by means of a not shown clasp nut. Through the movement of the operating rods 4 along the guide rails 31 it is possible to exert an operating force on the tailgate 2 and this can be used for opening or closing the tailgate. The motor drive is controlled by a diagrammatically represented control unit 6. In order to implement a jamming protection for a lower region of the tailgate frame 29 use is made of the evaluation of motor rotations per time unit as a function of a position of the tailgate 2. For an upper area of the tailgate frame 29 it is not possible to implement an evaluation of motor rotations per time unit in view of a clearly reduced lever arm between the tailgate 2 and hinges 7. Due to the limited lever arm, a jammed object or body part would not lead to a reliable release of the jamming protection device provided for the lower tailgate area. Therefore a profile arrangement in the form of a protective strip 8 is located on either side in the upper area of the tailgate frame. The protective strip 8 is connected to an evaluating unit 5 by a signal line 33. The evaluating unit 5 permanently carries out a closed-circuit current control of the protective strip 8 in order to be able to detect any mechanically or electrically occurring damage. If there is a closed-circuit current fault, a fault signal can be transmitted to a vehicle user. On moving the tailgate 2, it is possible to detect in the evaluating unit 5 a signal generated by the protective strip 8 as a result of the jamming of a body part or object and this signal is converted into a switching pulse. The switching pulse is transmitted by a switching line 34 to the control unit 6 for controlling the motor drive 3 and brings about there a rotation direction reversal thereof. Thus, the jammed body part or object can be freed again.

Unlike in FIG. 1a, FIG. 1b shows the fitting of the protective strip 8 to an inside of the tailgate facing the tailgate frame 29. Once again the tailgate is driven by pressure medium cylinders 56, which are supplied by a not shown pressure medium pump. In the embodiment shown the pressure medium cylinders 56 are movable in such a way that they perform both the opening and closing movement of the tailgate. It is alternatively possible in not shown manner to provide in addition to the pressure medium cylinders, movably positioned operating rods B, which control the tailgate opening and/or closing movement. Preferably an electric drive is associated with the operating rods B, which are diagrammatically illustrated in dot-dash line form. The signal generated by the protective strip 8 in the case of objects or body parts being jammed is detected in the evaluating unit 5 and converted into a switching pulse. By means of a switching line 34 the switching pulse is transmitted to the control unit 6 for controlling the hydraulic pump and brings about a rotation direction reversal there. Thus, the pressure medium cylinders 56 move the tailgate 2 up again and the jammed body part or object is released. A combination of the switching strips 8 on tailgate 2 with other, not shown electrical, hydraulic or pneumatic tailgate drives is also possible. The following description relates to the embodiment according to FIG. 1b, but can apply in the same way to the embodiment of FIG. 1a.

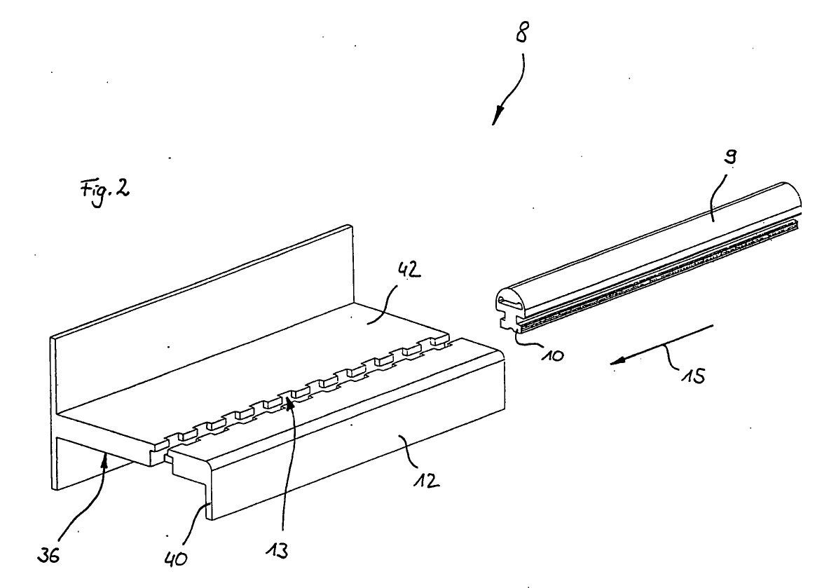

FIG. 2 shows a switching profile in the form of a switching strip 9, which is intended for installation on a support profile in the form of a holding rail 12 in a sliding direction 15. Thus, a fastening area of the switching profile constructed in substantially T-shaped manner as an armature profile 10 can be drawn into a T-slot 13 of the connecting portion of the holding rail 12. As a result of the corresponding design of the armature profile 10 and T-slot 13, following the sliding of the switching strip 9 into the holding rail 12, a positive connection takes place and forces can be supplied thereto in virtually all directions in space.

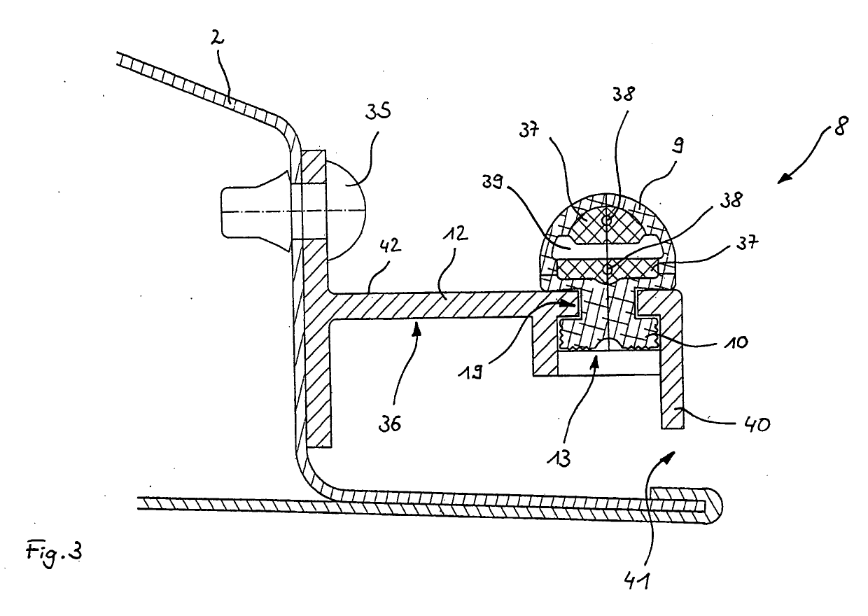

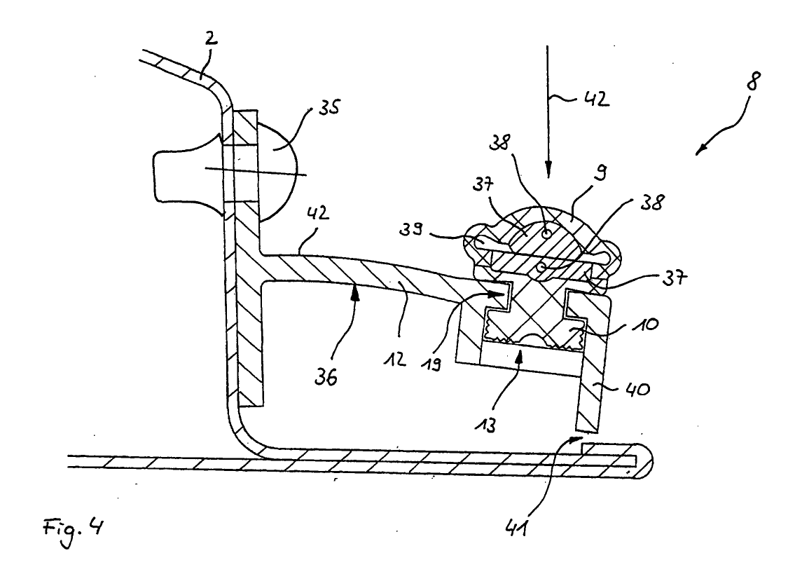

Following the installation of the switching strip 9 in the holding rail 12, the protective strip 8 according to the invention is produced. According to FIG. 3 the armature profile 10 and T-slot 13 form opposite undercuts 19, so as to bring about the desired positive connection between the switching strip 9 and the holding rail 12. The armature profile 10 and switching strip 9 are produced integrally from elastic materials in the extrusion process. The material used for the armature profile 10 is harder than the material used for the switching strip 9, because the armature profile 10 is mainly used for force transmission purposes, whereas the switching strip 9 is intended to have a high elasticity. In a hollow space formed by the armature profile 10 and switching strip 9 are provided conductive rubbers 37 separated by a switching gap 39 and which extend along the switching strip 9 and are in each case traversed by an electric supply wire 38. In a rest position of the switching strip 9, the switching gap 39 allows no electrical contact between the conductive rubbers. Under a force action, such as occurs when objects or body parts are jammed between the tailgate 2 and tailgate frame, there is a deformation of the switching strip 9, so that the conductive rubbers 37 come into contact and an electric current flow takes place. This situation is shown in FIG. 4. In order to simultaneously ensure a contusion protection up to a movement reversal of the tailgate 2, the holding rail 12 is provided with an elastic bending zone 36 permitting an evasion of the protective strip 8 and the jammed object. A safety gap 41 is provided between a stop member 40, which is part of the holding rail 12, and the tailgate 2. The stop member 40 is dimensioned in such a way that a braking path of the tailgate 2 up to the movement reversal is smaller than the safety gap 41. This ensures that there is no serious contusion risk for jammed body parts or damage risks for objects as a result of the tailgate 2. The holding rail 12 is joined to the tailgate 2 by plastic rivets 35.

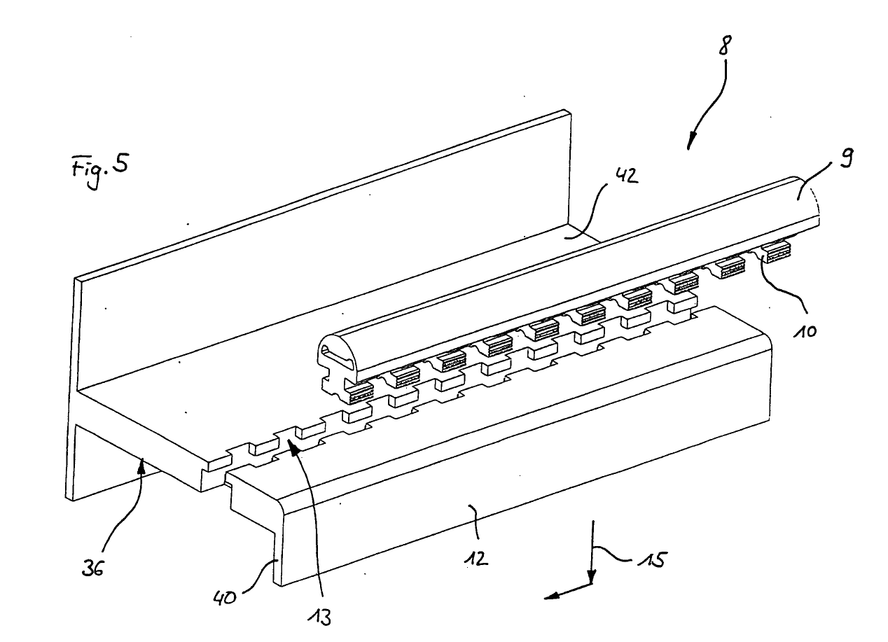

In the representation chosen in FIG. 5, as opposed to FIG. 3 a functional position of the protective strip 8 is shown, in which as a result of an operating force there has been a deformation of the switching strip 9 and consequently a contacting of the conductive rubbers. There is also a deflection of the holding rail along the bending zone 36. The safety gap 41 is reduced until there has either been a movement reversal of the tailgate 2 or the stop member 40 has run up onto the tailgate 2.

In order to simplify the fitting of the switching strip 9 in holding rail 12, according to FIG. 5 there is a partial removal of the armature profile 10, so that it is possible to fit in accordance with the sliding direction 15, as shown in FIG. 5. For the assembly process the armature profile 10 can be slid into the T-slot 13 past the locking elements in the form of retaining lugs 17 orthogonally to a contact surface 42 of the holding rail 12 and subsequently is brought into positive engagement with the holding rail 12 by a sliding movement parallel to the contact surface 42. It is unimportant whether the T-slot 32, as shown in FIG. 5, is open at the front or extends only zonally over a length of the holding rail 12.

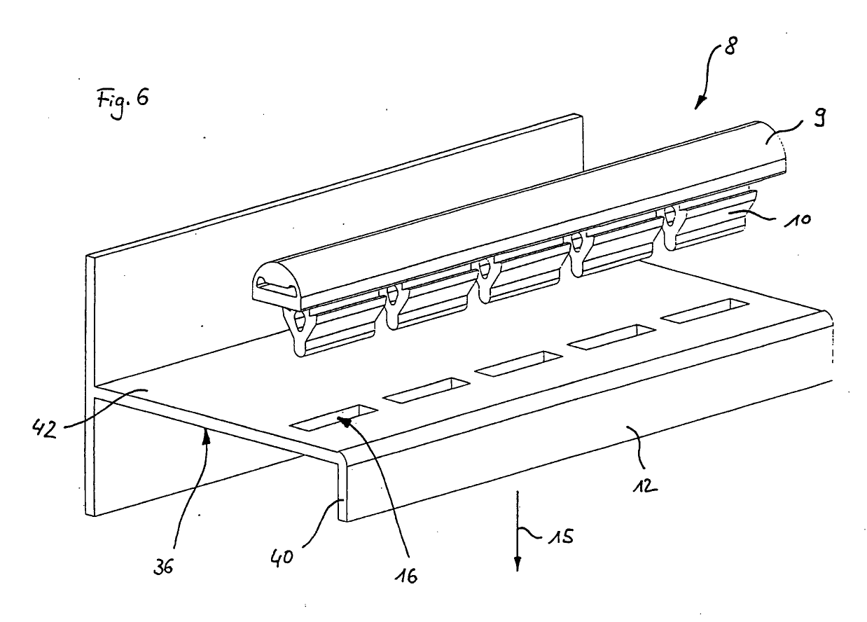

In the case of the protective strip 8 shown in FIG. 6 the armature profile 10 is once again partly removed and is additionally provided with a symmetrical insertion lug 43. This facilitates pressing into the locking recesses in the form of slits 16. The slits 16 have the same cross-section throughout and, following the pressing in of the protective strip 8, form the desired undercut with the armature profile 10.

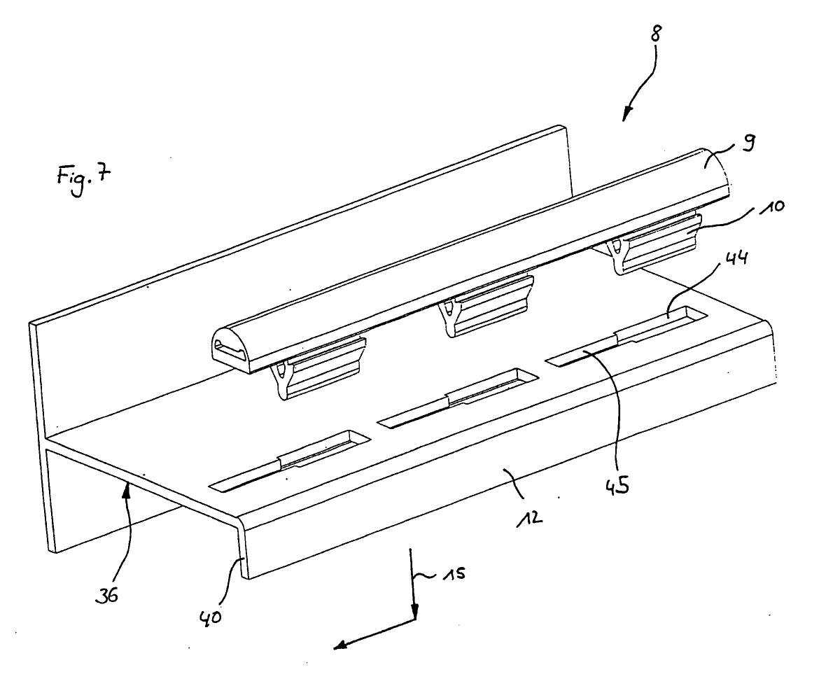

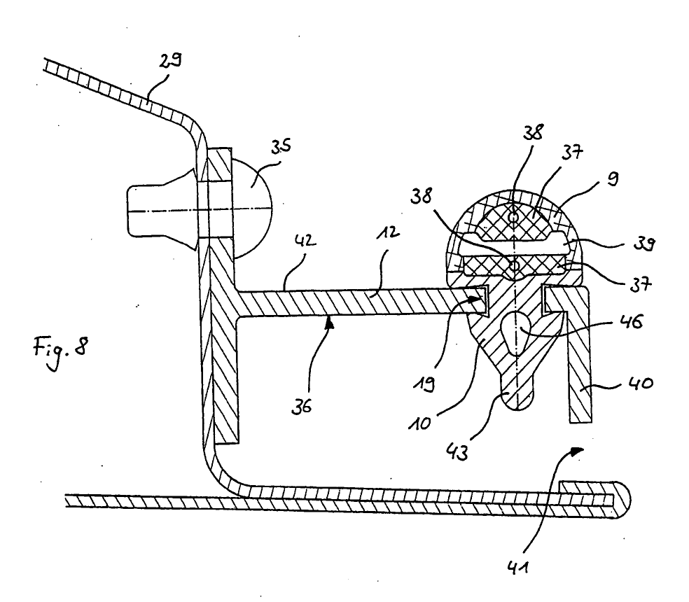

As opposed to this, FIG. 7 shows a protective strip 8, which is also only zonally provided with an armature profile 10, which has an insertion lug 43. The holding rail 12, diverging from FIG. 6, is provided with slits 16, which have a zonally differing cross-section in a parallel and orthogonal direction to the contact surface 42. In the holding rail 12 are provided a wide opening cross-section in the form of an insertion cross-section 44 and a narrow opening cross-section in the form of a holding cross-section 45. Whereas the insertion cross-section 44 at least approximately corresponds to the width of the armature profile 10, the holding cross-section 45 is matched to a web arrangement of the protective strip 8 in the form of a connecting web 14, in order to be able to form an undercut. An assembly situation such as can arise through the use of the holding rails shown in FIGS. 6 and 7 is illustrated in FIG. 8. It is particularly easy to see a deformation chamber 46 provided in the insertion lug 43 of the armature profile 10. The deformation chamber 46 facilitates an evasion of the armature profile 10 when the protective strip 8 is pressed into the holding rail 12.

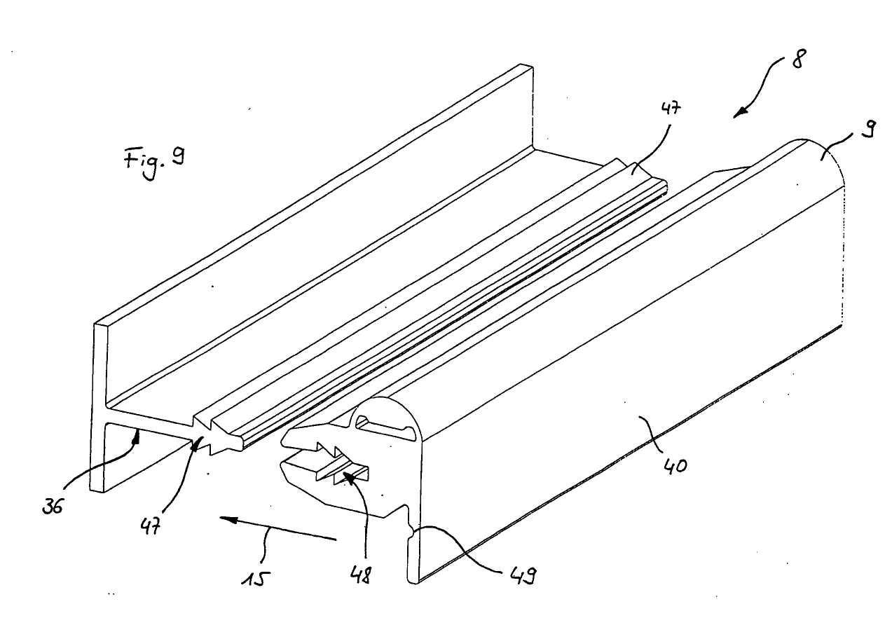

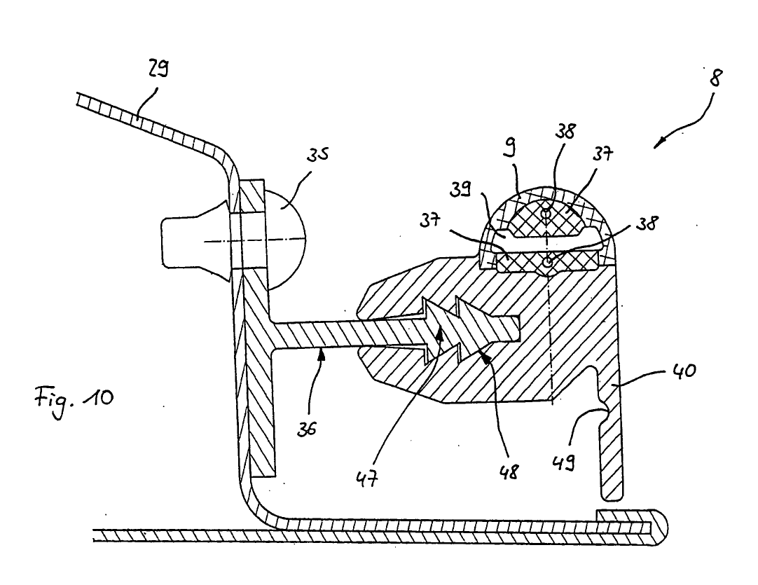

Unlike in the previously described embodiments of the invention, FIG. 9 shows a reversed arrangement of the T-slot and armature profile for the protective strip 8. For this purpose on the holding rail 10 is provided a raised wedge profiling 47 on which can be positively engaged in sliding direction 15 the switching strip 9. For this purpose the switching strip 9 has a profile groove 48, which is essentially adapted to the geometry of the wedge profiling 47. The safety gap between the protective strip 8 and the not shown tailgate frame is at least partly bridged in the embodiment of FIG. 9 by a flexible stop member 40 provided on the switching strip 9, so that the latter implements an optically pleasing termination of the protective strip 8 relative to the tailgate frame. The stop member 40 is additionally provided with a desired bending point 49. The interplay of tailgate frame 29, holding rail 12 and switching strip 9, as described in FIG. 9, can also be implemented in FIG. 10. FIG. 10 also shows in greater detail the internal structure of the switching strip 9. The conductive rubbers 37 in the rest position of switching strip 9 form the switching gap 39, said conductive rubbers 37 being equipped with supply wires 38. By means of its profile groove 48, the switching strip 9 is positively connected to the wedge profiling 47 of the holding rail 12 and, by means of the stop member 40, forms an optical termination of the protective strip 8 on the tailgate frame 29. In this embodiment, even in the rest position, the safety gap 41 can almost be negligible, because the residual path necessary for avoiding contusions can almost exclusively be ensured via the deformation of the stop member, particularly around the desired bending point 49.

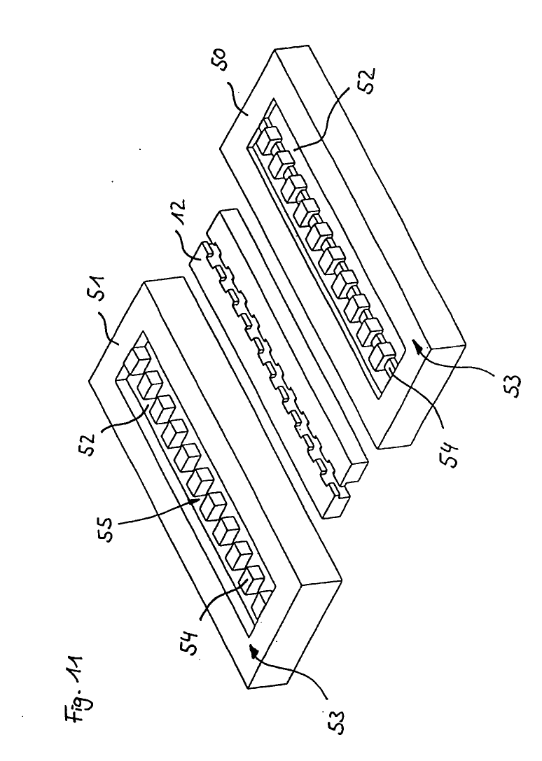

In the case of the halves of a plastic injection mould diagrammatically shown in FIG. 11, it is clear that both the upper mould half 50 and the lower mould half 51 in each case have part of the outer contour of the holding rail 12 as mould cavity 52. When using a plastic injection mould, the mould cavity 52 is formed by an areal joining together of the upper mould half 50 and lower mould half 51 in a common separating face in the form of junction plane 53. In other plastic injection moulds for the production of holding rails, in place of a junction plane 53 the separating surface can be in the form of a curved, three-dimensional surface. In both mould halves 50, 51 for the mould cavity 52 are in each case provided mould cores, which are rigidly placed in the cavity. The mould cores 54 form in the upper mould half 50 a closed row, which on injecting plasticized plastics material leads to a through, undercut slot in the support profile. In the lower mould half 51 an arrangement of the mould cores 54 is chosen so that there are gaps 55 between the individual cores 54. As a result of the gaps 55 the crossbars necessary for the cohesion of the holding rail 12 are formed. The mould halves 50, 51, including the mould cores 54, are designed in such a way that following the injection and complete hardening of the plastics material, the mould halves can be easily flapped open. The finished support profile can be removed, without it being necessary to carry out additional mould removal measures, such as the movement or removal of sliders or mould cores.

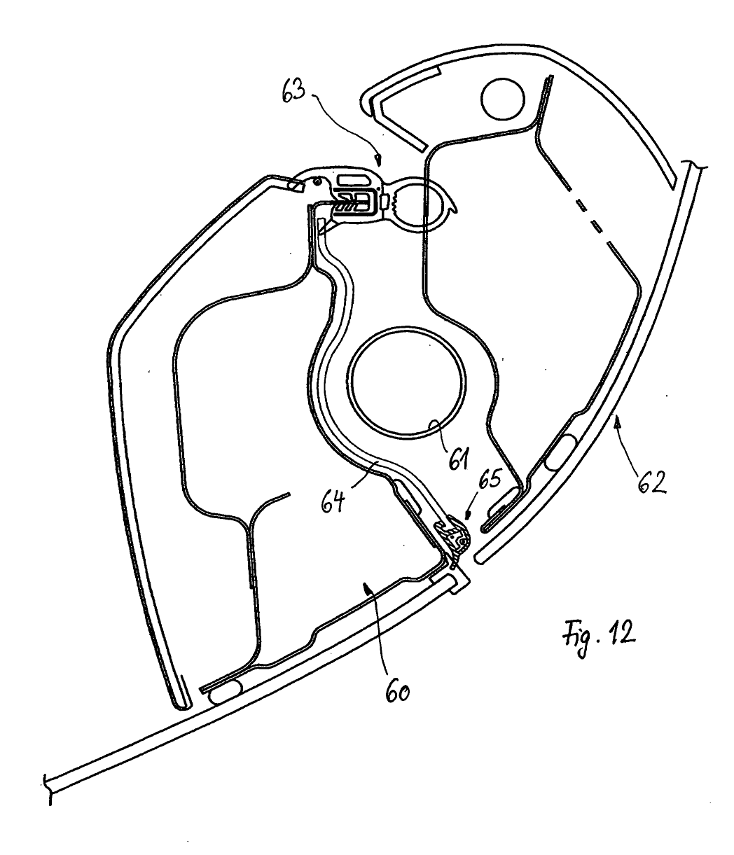

In the embodiment according to FIGS. 12 to 14 a tailgate 62 is pivotably mounted relative to a tailgate frame of the body support structure of a motor vehicle in the same way as in the embodiment according to FIG. 1a. As in the embodiment according to FIG. 1a, the tailgate 62 is provided with a motor closing drive, which permits an automatic closing movement of the tailgate 62. In order to obtain an all-round, tight closure with the body-side tailgate frame 60 in a closing position of the tailgate 62, a sealing profile 63 is provided, which is engaged on a web-like flange of a body panel of the tailgate frame and consequently the body support structure. The sealing profile 63 is formed by an elastomer profile, in which is provided a metallic, U-shaped profile reinforcement in order to bring about a secure, non-positive retention of the sealing profile 63 on the body panel flange. For further details reference is made to the representation in FIG. 12.

In the opening direction the tailgate 62 is movable by gas pressure springs as in the embodiment according to FIG. 1a. In FIG. 12 such a gas pressure spring carries the reference numeral 61.

When the tailgate 62 is open, an area of the tailgate frame 60 directed towards the interior is provided with a cladding part 64 in order to cover the body panel of the tailgate frame 62. The cladding part 64 is made from plastic and extends at least substantially over an entire height of the given lateral frame part of the tailgate frame 60. The lateral frame parts of the tailgate frame 60 flank the tailgate opening on both sides and are preferably parts of the D-columns of the body support structure.

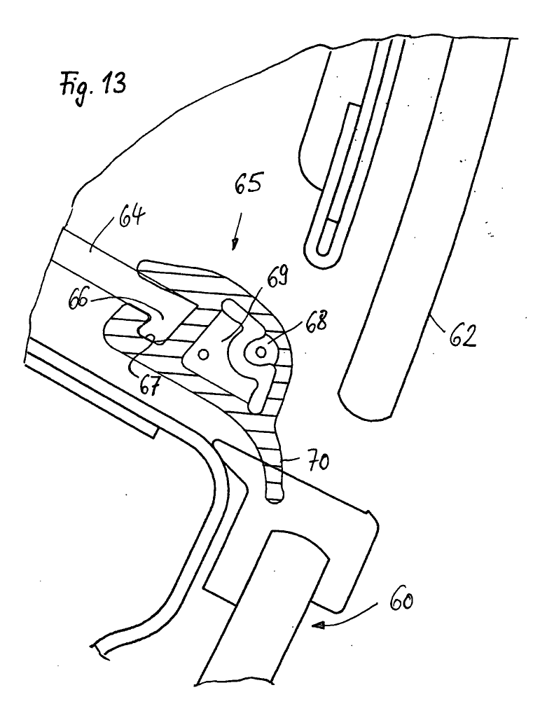

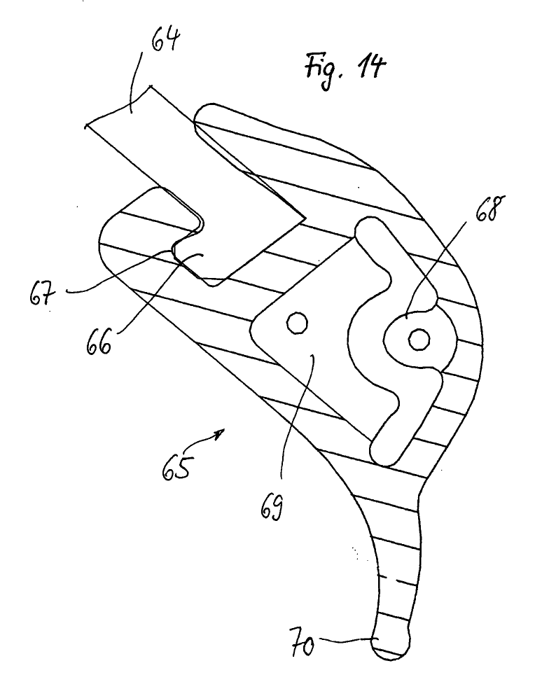

In order to ensure during a motor closing movement of the tailgate 62 that articles or limbs such as fingers or hands are not jammed between the lateral flanks of the tailgate 62 and the lateral parts of the tailgate frame 60, a jamming protection in the form of a switching profile 65 is provided and the fundamental function thereof corresponds to the previously described embodiments. As is apparent from FIGS. 13 and 14, the switching profile 65 is firstly provided with a fixing portion which, in a manner to be described hereinafter, is joined to the cladding part 64. Secondly there is a switching chamber portion within the switching profile and which is formed by a closed hollow profile portion. The hollow profile portion contains two facing, electrically conductive contact areas 68, 69, which are separated from one another in the unloaded state. In the unloaded state an insulating gap is left between the contact areas 68, 69. As soon as an object or body part is pressed from the outside against the outer face of the switching profile 65, the latter is deformed, so that contact area 68 approaches contact area 69. As a function of the level of the pressure loading the contact area 68 comes into contact with the contact area 69, so that a corresponding switching signal is produced, which in fundamentally known manner is correspondingly evaluted by an electronic control unit. This switching signal preferably brings about a reversal of the motor closing drive, so that the jammed object or body part again becomes free and can be extracted from the remaining gap between the tailgate 62 and tailgate frame 60. This makes it possible to in particular avoid injury risks to persons located in the tail area of the motor vehicle during a closing movement of the tailgate 62.

The switching profile 65 is provided with a slot 67 which, considered in cross-section, is constructed in L-like manner and is open to one longitudinal side of the switching profile 65. Preferably the slot 67, which serves as a plug-in profiling in the sense of the invention, is also open to at least one of its front ends. Matched to the slot 67, the cladding part 64 has a corresponding L-shaped web arrangement 66, onto which the switching profile can be drawn from one front end of the web arrangement 66 with its slot 67. The switching profile 65 extends over the entire length of the cladding part 64 and is provided on a longitudinal marginal area of the cladding part 64 directed towards the outside. Prior to the mounting of the cladding part 64 on the tailgate frame 60, the switching profile 65 is preferably drawn onto the cladding part 64 and then, together with the latter, is mounted on the tailgate frame 60. The fixing portion of the switching profile 65 is constructed in a limited elastically resilient manner. Compared with the cross-section of the web arrangement 66, the slot 67 has a slightly tapered cross-section, as can be gathered from FIG. 14. On drawing the slot 67 onto the web arrangement 66 it is consequently elastically widened below a nose-like holding portion of the web arrangement 66, so that in the drawing-on direction there is a frictional connection between the fixing portion of the switching profile 65 and the web arrangement 66 of the cladding part 64. The fixing portion of the switching profile 66 is also held positively on the cladding part 64 at right angles to the drawing-on direction. A web leg of slot 67 engages behind the nose-like holding portion of the web arrangement 66. The nose-like holding portion is angled in hook-like manner by somewhat more than 90° in order to bring about a further improved, positive engagement of the web leg of the slot 67 on the holding portion of the web arrangement 66 (FIG. 14). The slot 67 has a hollow chamber, which also has an angling by more than 90°, matched to the nose-like holding portion of the web arrangement 66. For further geometrical details reference should be made to the larger scale representation of FIG. 14.

While the invention has been described in connection with various embodiments, it will be understood that the invention is capable of further modifications. This application is intended to cover any variations, uses or adaptations of the invention following, in general, the principles of the invention, and including such departures from the present disclosure as known, within the known and customary practice within the art to which the invention pertains.

1. A profile arrangement with a support profile in the form of a plastic injection moulding and with an at least zonally, elastically flexible switching profile, which is connected by means of a fastening area to a corresponding connecting portion of the support profile, wherein the connecting portion of the support profile and the fastening area of the switching profile are constructed as positively interconnectable plug-in profilings.

2. The profile arrangement according to claim 1, wherein the switching profile is constructed as a hollow profile without a switching function.

3. The profile arrangement according to claim 1, wherein at least one plug-in profiling of the support profile or switching profile is constructed as a slot open to at least one face and that at least one corresponding plug-in profiling of the switching profile or support profile is constructed as a web arrangement matched to a cross-section of the slot for fitting into one another in the drawing-on direction.

4. The profile arrangement according to claim 3, wherein the web arrangement and the at least one slot are so positively matched to one another that a positive retention at right angles to the sliding direction is ensured.

5. The profile arrangement according to claim 1, wherein the at least one plug-in profiling of the support profile is constructed as a locking recess and the at least one plug-in profiling of the switching profile is constructed as a lug or web-like locking element, which can be plugged into one another at right angles to an opening plane of the locking recess, and that the locking recess and locking element have at least one undercut ensuring a positive retention of the locking element in the locking recess counter to an insertion direction.

6. The profile arrangement according to claim 5, wherein a longitudinal extension of the locking recess is larger than a corresponding extension of the locking element and that the locking recess, considered in the longitudinal extension, has at least two differingly wide opening cross-sections, the differing opening cross-sections being matched to different cross-sectional areas of the locking element, whereof a cross-sectional area at the front in the insertion direction forms an undercut area and a following cross-sectional area forms a sliding area.

7. The profile arrangement according to claim 1, wherein the sliding area or the corresponding opening cross-section vary in cross-section in the sliding direction.

8. The profile arrangement according to claim 1, wherein the connecting portion of the support profile is constructed as an extension of an elastically flexible compensating portion.

9. The profile arrangement according to claim 3, wherein in the longitudinal direction, in the vicinity of a top side, the slot is provided in alternating, pairwise manner with in each case a larger and a smaller opening cross-section and in the vicinity of its underside with crossbars and recesses, the crossbars facing the larger opening cross-sections and the recesses facing the smaller opening cross-sections.

10. An injection mould for the manufacture of a support profile for the profile arrangement according to claim 2, wherein an external geometry of the support profile to be manufactured is made as a mould cavity in at least two mould parts, which are in contact in a common junction plane and have mould cores, which are at least approximately orthogonally positioned with respect to the junction plane and in a functioning position bound a slot of the support profile undercut with respect to the junction plane.

11. An injection mould for the manufacture of a support profile for the profile arrangement according to claim 3, wherein an external geometry of the support profile to be manufactured is made as a mould cavity in at least two mould parts, which are in contact in a common junction plane and have mould cores, which are at least approximately orthogonally positioned with respect to the junction plane and in a functioning position bound a slot of the support profile undercut with respect to the junction plane.

12. The profile arrangement according to claim 2, wherein at least one plug-in profiling of the support profile or switching profile is constructed as a slot open to at least one face and that at least one corresponding plug-in profiling of the switching profile or support profile is constructed as a web arrangement matched to a cross-section of the slot for fitting into one another in the drawing-on direction.

13. The profile arrangement according to claim 12, wherein the web arrangement and the at least one slot are so positively matched to one another that a positive retention at right angles to the sliding direction is ensured.
